(19) United States
(12) Patent Application Publication
(10) Pub. No.: US 2004/0223060 A1
(43) Pub. Date: Nov. 11, 2004

(54) Control system, control method, printing system, and image data control apparatus and program

(76) Inventor: Tomonaga Yasuda, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 10/830,654

(22) Filed: Apr. 23, 2004

(30) Foreign Application Priority Data
May 7, 2003 (JP) 2003-129476

(51) Int. Cl. H04N 5/225

(52) U.S. Cl. 348/207.1

(57) ABSTRACT

The present invention provides a control system which can be easily operated even by a user inexperienced in handling external devices such as PCs, control devices and printers, and in which compatibility between these devices can be readily achieved. The control system includes: a first external device having a receiving unit for receiving a program, the first external device capable of operating based on the received program; a second external device capable of operating in association with a command, which is generated from the first external device on the basis of the program received by the first external device; and a control device. When it is determined that the first and second external devices are controllably connected, the control device selects a program to allow the first and second external devices to be operatively associated with each other and transmits the selected program to the first external device. The second external device is controlled by the command generated from the first external device.

This application claims benefit of Japanese Application No. 2003-129476 filed on May 7, 2003, the contents of which are incorporated by this reference.

### BACKGROUND OF THE INVENTION

1. Field of the Invention

The present invention relates to a control system, a control method, a printing system, and an image data control apparatus and program.

2. Description of the Related Art

In recent years, digital still cameras have been widely diffused. Each digital still camera includes storage means for recording an image of a subject as image data which is digital. An image based on image data recorded in the digital still camera is generally printed through a printer connected to a personal computer (hereinbelow, abbreviated to PC). In this case, a user connects the digital still camera to the PC, operates the PC so as to read image data stored in the storage means of the digital still camera and generate the read image data to the printer, and generates a print instruction to the printer through the PC.

However in the case where the user generates a print instruction to the printer using the PC to print an image based on image data stored in the digital still camera, if the user is inexperienced in PC operations, the user cannot easily print the image based on the image data stored in the digital still camera. So, for example, Japanese Unexamined Patent Application Publication No. 2001-238156 discloses an image printing system. In the system, when a digital still camera is connected to a PC, image data is automatically transferred from the digital still camera to the PC to produce print data and execute printing, so that an image based on the image data is printed. According to the system, if a user is inexperienced in PC operations, he or she can easily print an image.

Also, Japanese Unexamined Patent Application Publication No. 2000-32321 discloses an apparatus capable of performing various settings of a camera using a PC. According to the apparatus, a user changes a shooting mode through the PC to remotely control the camera. Japanese Unexamined Patent Application Publication No. 2000-32321 also provides a technique of detecting the performance of a printer connected to the PC, transmitting a photographic image suitable for the performance from the PC to the printer, and further, allowing the camera to refer to the printer for information regarding the performance thereof and request the transmission of information from the printer.

### SUMMARY OF THE INVENTION

Accordingly, it is an object of the present invention to provide a control system including: a first external device having a receiving unit for receiving a program, the first external device being capable of operating based on the program received through the receiving unit; a second external device capable of operating in association with a command which is generated from the first external device on the basis of the received program; and a control device for selecting a specific program for allowing the first and second external devices to be operatively associated with each other when it is determined that the first and second external devices are controllably connected, and transmitting the selected program to the first external device, wherein the second external device is controlled based on the command generated from the first external device.

### BRIEF DESCRIPTION OF THE DRAWINGS

FIG. 1 is a diagram of the structure of an image data control system according to an embodiment of the present invention;

FIG. 2 is a block diagram showing the respective structures of a digital still camera (DSC), a personal computer (PC), and a printer according to the embodiment of the present invention;

FIG. 3 is a flowchart of a process executed by the PC when the DSC is connected to the PC;

FIG. 4 is a flowchart of a process in the DSC;

FIG. 5 shows an example of a window displayed in a display unit of the DSC;

FIG. 6 is a flowchart of a process performed when the PC receives data related to a control command and operates according to the control command;

FIG. 7 shows an example of a window indicating that the printer is printing;

FIG. 8 shows an example of a window indicating the occurrence of a paper jam;

FIG. 9 is a flowchart of a process including status change processing and error handling processing in the PC;

FIG. 10 shows an example of a window displayed in the display unit of the DSC; and

FIG. 11 shows an example of another window displayed in the display unit of the DSC.

### DETAILED DESCRIPTION OF THE PREFERRED EMBODIMENT

An embodiment of the present invention will now be described hereinbelow with reference to the drawings.

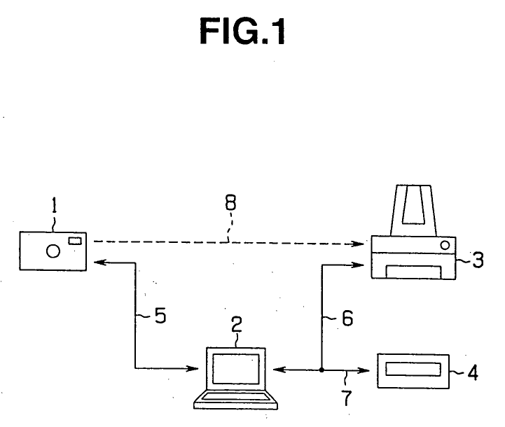

FIG. 1 shows the structure of an image data control system according to the present embodiment. The structure thereof will now be described.

Referring to FIG. 1, a digital still camera (hereinbelow, abbreviated to DSC) 1 is capable of storing image data of a subject to a storage medium included therein or connected thereto. The image data is captured through an image pick-up device built in the DSC 1. A personal computer (PC) 2 serves as a control device and includes a storage device such as a hard disk drive (hereinbelow, abbreviated to HDD) for storing a program, which will be described later. The storage device stores a program for various processes such as a determining process, a program producing process, and a process of transmitting a control command to a printer. The processes will be described later. A printer device (hereinbelow, referred to as a printer) 3 prints an image on paper on the basis of received image data. A magnet-optical disk drive (hereinbelow, abbreviated to MO) 4 is capable of storing image data. The printer 3 and the MO 4 handle image data obtained through the DSC 1. For example, the printer 3 prints an image based on the image data and the MO 4 stores the image data.

The PC 2 is connected to the DSC 1 through a connection cable 5 such as a Universal Serial Bus (USB) cable. The PC 2 is connected to the printer 3 through a connection cable 6 such as a USB cable. The PC 2 is connected to the MO 4 through a connection cable 7 such as a USB cable. Therefore, the PC 2 serving as the control device can communicate with the DSC 1, the printer 3, and the MO 4 serving as external devices through the connection cables 5, 6, and 7, respectively. As will be described later, the PC 2 can transmit a produced or selected program to the DSC 1 through the corresponding connection cable, convert data supplied from the DSC 1 into a printer control command, and transmit the command to each of the printer 3 and the MO 4 through the corresponding cables.

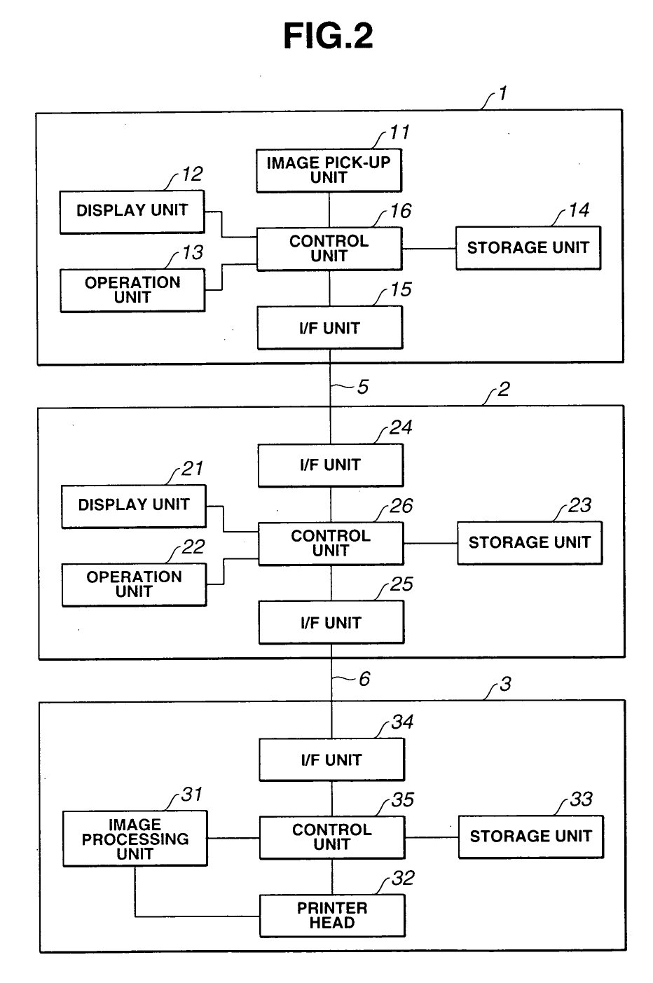

FIG. 2 is a block diagram showing the respective structures of the DSC 1, the PC 2, and the printer 3. The DSC 1 includes: an image pick-up unit 11 having a solid-state imaging element such as a charge coupled device (CCD); a display unit 12 having a liquid crystal display (hereinbelow, referred to as an LCD) arranged on the exterior of the DSC 1; an operation unit 13 serving as an operating member for entering an input for controlling the DSC 1, the operation unit 13 including a shutter button and a self-timer button and the like, which are arranged on the exterior of the DSC 1 and are used to realize various operations by a user; a storage unit 14 for storing image data of a subject image captured through the image pick-up unit 11; a communication interface unit (hereinbelow, referred to as an I/F unit) 15 for communicating data with the PC 2; and a central processing unit (hereinbelow, abbreviated to CPU) 16 serving as a control unit.

The DSC 1 has similar functions as those of a normal digital still camera. In other words, the DSC 1 is capable of capturing an image of a subject, storing image data to the storage unit 14, and transmitting the image data to the PC 2 so long as the DSC 1 is connected to the PC 2 through the connection cable 5. Further, the DSC 1 can receive a program in a predetermined format from the PC 2 and execute the program using the CPU 16 and a RAM (not shown) in a predetermined mode. The program is selected or produced by the PC 2. Executing the program in the predetermined format will be described later.

The PC 2 includes: a display unit 21 such as an LCD; an operation unit 22 such as a keyboard or a similar device; a storage unit 23 such as an HDD for storing various programs to realize various processes and various data including table data and the like, which will be described later; an I/F unit 24 for communicating data with the DSC 1; an I/F unit 25 for communicating data with the printer 3; and a CPU 26 serving as a control unit.

The PC 2 has similar functions as those of a general computer. The PC 2 further includes a function of performing the various processes stored in the storage unit 23. The various processes will be described later.

The printer 3 includes an image processing unit 31 for performing various image processing operations to image data so that an image based on the image data can be printed; a printer head 32 for printing the image on a medium such as paper; a storage unit 33 for storing data used to print an image on the medium; an I/F unit 34 for communicating data with the PC 2; and a CPU 35 serving as a control unit.

The printer 3 has a function of performing each of various processes in accordance with the corresponding control command when receiving the command from the PC 2.

The structure of the MO 4 is omitted here. The structure thereof is similar to that of a general magnet-optical disk drive.

Data communication between the DSC 1, the PC 2, and the printer 3 and processes in the DSC 1, the PC 2, and the printer 3 will now be described hereinbelow.

The PC 2 transmits a produced or selected program to the DSC 1 and receives data therefrom. The produced or selected program will be described later. The communication between the PC 2 and the DSC 1 is performed through the I/F unit 24, the connection cable 5, and the I/F unit 15. Similarly, the PC 2 transmits a print control command to the printer 3 and receives data indicating status information of the printer. The communication between the PC 2 and the printer 3 is performed through the I/F unit 25, the connection cable 6, and the I/F unit 34.

As will be described later, according to the present embodiment, the program is transmitted from the PC 2 to the DSC 1 and is executed in the DSC 1. A window (indication) based on the program is displayed in the DSC 1. The user operates the DSC 1 in accordance with information in the window, so that he or she can generate an instruction to operate the printer 3. Consequently, as shown by a dashed arrow 8 in FIG. 1, the user of the DSC 1 can operate the printer 3 through the DSC 1.

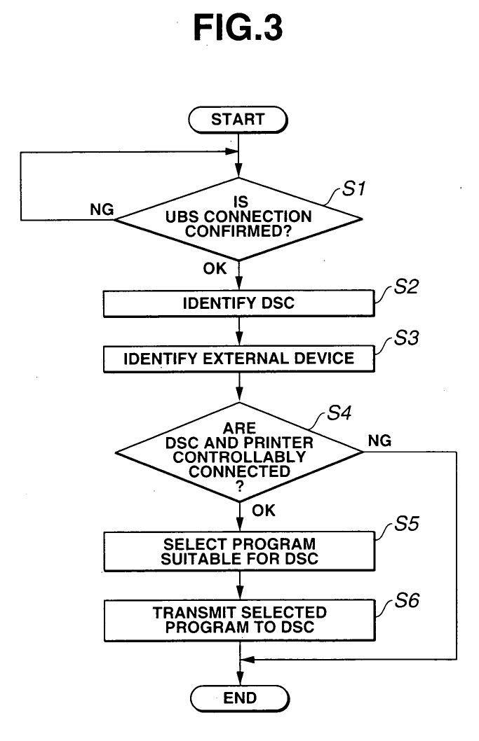

FIG. 3 is a flowchart of a process performed through the PC 2 when the DSC 1 is connected to the PC 2 that is already connected to the printer 3 and the MO 4. Since the PC 2 is already connected to the printer 3, various control commands can be transmitted from the PC 2 to both of the printer 3 and the MO 4 and status information such as information indicating the operating mode can be transmitted from the printer 3 and the MO 4 to the PC 2.

First, the PC 2 checks the USB connection with the DSC 1 (step (abbreviated to S) 1). If the USB connection is not confirmed, steps subsequent to S1 in FIG. 3 are not performed. If YES in S1, whether the DSC 1 is connected to the printer 3 such that the printer 3 and the MO 4 can handle image data stored in the DSC 1 is determined.

In S2, the PC 2 identifies the DSC 1. In identifying the DSC, the type of the DSC 1 connected via the USB cable, namely, the maker and the model number of the DSC and the version of firmware are checked. The DSC 1 can be identified using a function of a USB interface serving as a physical layer that is defined as a communication interface. When the DSC 1 and the PC 2 support an image transfer protocol such as Picture Transfer Protocol (PTP), the DSC 1 can be identified using a function of the image transfer protocol.

Subsequently, the PC 2 identifies the printer 3 serving as an external device (S3). The type of the printer 3, namely, the maker and the model number thereof are checked.

On the basis of the results of S2 and S3, whether the DSC 1 and the printer 3 are controllably connected to the PC 2 so that image data stored in the DSC 1 can be handled in the printer 3 and the MO 4 is determined (S4). If YES, the process proceeds to S5. If NO, the flow is terminated without processing.

The determination in S4 is made from whether a program supporting the type of DSC and the type of printer, identified in S2 and S3, is prepared. The program supporting the type of DSC and the type of printer will be described later. The CPU 26 and processing S1 to S4 performed by the CPU 26 define a determining unit for determining whether the DSC 1 is controllably connected to the PC 2.

Subsequently, the PC 2 selects a program, which is suitable for the DSC 1 and is transmitted thereto, from a plurality of programs previously stored in the storage unit 23 of the PC 2 on the basis of the combination of the DSC 1 and the printer 3. The programs supporting various types of DSC and various types of printers are previously stored in the storage unit 23 of the PC 2 so that the user can designate a control command for the printer 3 in the DSC 1 and the status of the printer 3 can be displayed in the DSC 1. A program in a predetermined format suitable for the DSC 1 is selected among the stored programs in accordance with the respective types checked in S2 and S3 (S5).

The selected program is transmitted to the DSC 1 and is executed through the CPU 16 in the DSC 1. Consequently, the user can designate a control command to be transmitted from the DSC 1 to the printer 3. Specifically, after the selected program is executed in the DSC 1, as will be described later, the DSC 1 is set to a predetermined mode and a predetermined window (indication) is displayed in the display unit 12 of the DSC 1, thus realizing an input function for designating a control command for the printer 3 using the operation unit 13 of the DSC 1. In S5, therefore, the PC 2 selects a program to produce a window suitable for the size of a screen of the display unit 12 in the DSC 1, the number of buttons in the operation unit 13, the kinds of buttons, and the performance, functions, and structure and the like of the DSC 1.

Further, the program should also support the performance, functions, and structure and the like of the printer 3. Therefore, data in a table format to determine a program, which is selected based on the maker and the model number of the DSC 1 and those of the printer 3, is stored in the storage unit 23 of the PC 2. A program is selected based on the table data stored in the storage unit 23 of the PC 2. A plurality of programs supporting various types DSCs and printers are further stored in the storage unit 23 of the PC 2. Specifically, therefore, the PC 2 selects a program with a predetermined format to be executed in the DSC 1 from among the programs on the basis of the model number of the DSC 1 and that of the printer 3 checked in S2 and S3.

The suitable program can be selected on the basis of not only the type of the DSC 1 and that of the printer 3 but also table data supporting the functions of the DSC 1 and those of the printer 3. In other words, a display function and an operating function of the DSC are recognized and a program supporting the recognized functions and the functions of the printer 3 can be selected. For example, if the PC 2 can support a direct print protocol such as PictBridge, the PC 2 recognizes the functions of the DSC using functions of the protocol such as PictBridge.

Specifically, the PC 2 recognizes the functions of the DSC 1 using a discovery function, which is one of the functions of PictBridge. For example, the PC 2 transmits a virtual file to the DSC 1 in order to recognize which format the DSC 1 has files in. Alternatively, the PC 2 requests a file list to the DSC 1, the file list indicating what kinds of files the DSC 1 contains. Thus, the PC 2 recognizes the functions of the DSC 1 and selects a program supporting the functions of the DSC 1 among the stored programs.

As mentioned above, the PC 2 selects a program to be transmitted to the DSC 1 among the stored programs and then transmits the selected program to the DSC 1. Alternatively, each time, the PC 2 can produce a program, suitable for the respective types or functions of the DSC 1 and the printer 3, on the basis of the types or functions thereof and then transmit the produced program to the DSC 1. The CPU 26 and processing in S5 executed through the CPU 26 define a program producing unit for producing or selecting an operating program for allowing the DSC 1 and the printer 3 to be operatively associated with each other.

The PC 2 transmits the selected program to the DSC 1 (S6). As will be described later, the selected program has a predetermined form. The program allows the display unit 12 of the DSC 1 to display a window used to control the printer 3 by the user so that he or she can generate a print instruction from the DSC 1 to the printer 3 in accordance with information in the window. Additionally, the program, transmitted through the PC 2, can allow the display unit 12 of the DSC 1 to display the status of the printer 3. The CPU 26 and processing in S6 executed by the CPU 26 define a program transmitting unit for transmitting an operating program to the DSC 1.

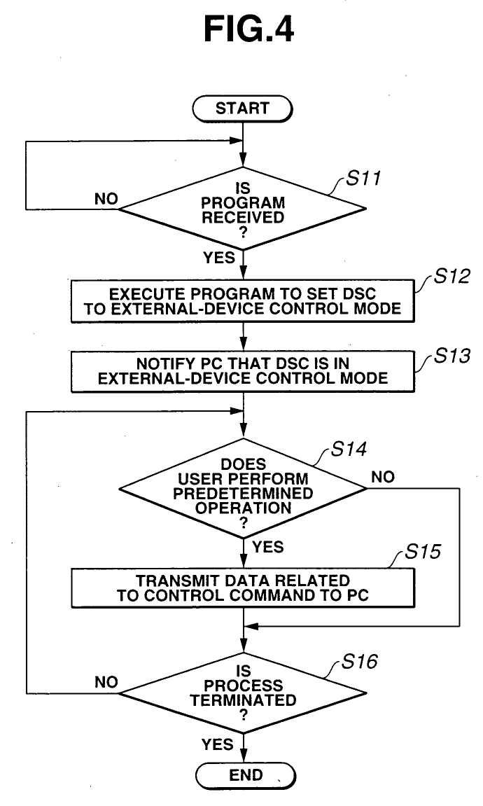

FIG. 4 is a flowchart of a process performed in the DSC 1. First, the DSC 1 determines whether a program in a predetermined form is received from the PC 2 (S11). The CPU 16 and processing in S11 executed by the CPU 16 define a receiving unit for receiving an operating program from the PC 2. If the DSC 1 does not receive any operating program in a predetermined form from the PC 2 (NO in S11), the process is not performed. The DSC 1 has executing means capable of executing a program in a predetermined form transmitted from the PC 2. The executing means is defined by the CPU and the RAM, which are included in the control unit 16. Accordingly, when receiving a program in a predetermined form from the PC 2, the DSC 1 allows the executing means to execute the received program, so that the DSC 1 is set to an external-device control mode (S12). The CPU 16 and processing in S12 executed through the CPU 16 define an executing unit for executing the operating program transmitted from the PC 2. The DSC 1 transmits data to the PC 2 to notify the PC 2 that the DSC 1 is in the external-device control mode (S13).

After the DSC 1 is in the external-device control mode, a part or the entire of the display function of the display unit 12 and the operating function of the operation unit 13 do not act as the functions of the normal digital still camera. For example, as will be described later, a predetermined button functions as a button to operate the printer 3.

When the program received in S12 is executed, the display unit 12 of the DSC 1 displays a window (indication) produced according to the program. The window includes an indication item of the status of the printer 3 and an indication item used to transmit a command to the printer 3.

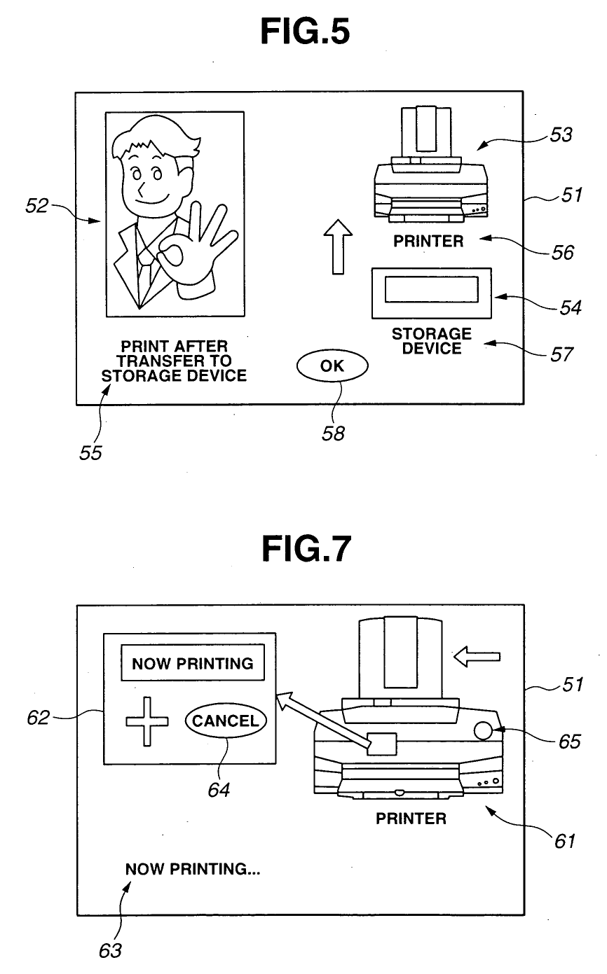

FIG. 5 shows an example of a window in the display unit 12. Within a frame 51 of the display unit 12 such as an LCD, a picture 52 of a man, the picture indicating that an image can be printed through the printer 3 after image data is stored to the MO 4, a picture 53 of a printer, a picture 54 of an MO, a character string 55 of “PRINT AFTER TRANSFER TO STORAGE DEVICE”, a character string 56 of “PRINTER”, and a character string 57 of “STORAGE DEVICE” are displayed. The window includes a button 58 indicating a command of “PRINT”.

If indication items of the window in the display unit 12 change in association with the operation selected by the user, the PC 2 can transmit a program or window data to display a window corresponding to the selected operation every window selected from among a plurality of windows in S5, and the DSC 1 can display a window based on the program or window data received every selected operation in S11 and S12.

On condition that the above-mentioned window is displayed in the display unit 12 of the DSC 1, whether the user performs a predetermined operation is determined (S14). For example, to transfer image data stored in the DSC 1 to the MO 4, store the data thereto, and then print an image based on the image data through the printer 3, the user moves a cursor onto the displayed button 58 by using arrow key, one of the operation unit 13 of the DSC 1, and presses, namely, selects the button 58. In this instance, it is determined that the user has performed the operation (YES in S14). After that, data related to a control command for the printer 3 and the MO 4 is transmitted, namely, generated from the DSC 1 to the PC 2 (S15). As mentioned above, the display unit 12 of the DSC 1 can display indication items so that the user can select a command related to the execution of the printer 3 and the MO 4. The user can select the command to the printer 3 and the like with reference to the indication items. The CPU 16 and processing in S15 executed by the CPU 16 define a generating unit for generating a control instruction for the printer 3. In the DSC 1, whether the terminating operation is performed is determined (S16). If YES in S16, the process is terminated. If NO, the process is returned to S14. The process can be terminated each time data related to a control command corresponding to one window is transmitted. Alternatively, the process can be finished when the connection cable is disconnected from the DSC 1 or the printer 3.

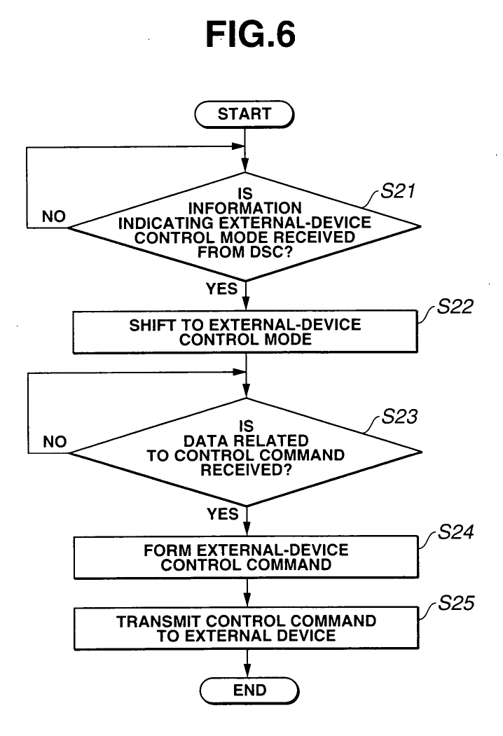

A process in the PC 2 will now be described. The process is performed when data related to a control command is transmitted from the DSC 1 to the PC 2. FIG. 6 is a flowchart of the process performed when the PC 2 receives data related to a control command and operates according to the control command.

First, whether the PC 2 receives information indicating that the DSC 1 is in the external-device control mode is determined (S21). The information is transmitted from the DSC 1 to the PC 2 in S13 of FIG. 4. If YES, the PC 2 enters the external-device control mode (S22). Whether the PC 2 receives data related to a control command from the DSC 1 is determined (S23). The CPU 26 and processing in S23 performed by the CPU 26 define a receiving unit for receiving data produced according to a program, which is transmitted to the DSC 1 and is executed therein. If YES in S23, the PC 2 analyzes the received data related to the control command and converts the data into an external-device control command. Alternatively, the PC 2 forms an external-device control command based on the received data related to the control command (S24). The CPU 26 and processing in S24 performed by the CPU 26 define a control command forming unit for forming a control command for the printer 3 based on data transmitted from the DSC 1.

For example, the PC 2 recognizes the indication items in the window in the display unit 12 of the DSC 1. Therefore, the PC 2 can recognize a control command designated in the window by the user. For example, it is assumed that the “OK” button 58 is selected while the indication items shown in FIG. 5 appear in the display unit 12. The PC 2 receives data related to a command to store image data to the MO 4 and then print an image based on the image data through the printer 3. Therefore, the PC 2 forms an external-device control command so that image data is stored to the MO 4 and an image based on the image data is then printed through the printer 3, and then transmits the command to each of the MO 4 and the printer 3 (S25). Thus, the MO 4 stores the image data supplied from the DSC 1. After that, the printer 3 prints an image based on the image data. The CPU 26 and processing in S25 performed by the CPU 26 define a generating unit for generating a control command for the printer 3.

FIG. 5 shows the case where the printer 3 and the MO 4 are displayed in the window and the image is printed through the printer 3 after the image data is stored to the MO 4. If only the printer 3 is connected to the PC 2 and an image is printed through the printer 3, the printer 3 alone is included in the window but the MO 4 is not displayed.

The display unit 12 of the DSC 1 displays the respective statuses of the printer 3 and the MO 4 serving as the external devices. The printer 3, the MO 4, and the PC 2 are ready for data communicate therebetween. If the status of the printer 3 or the MO 4 changes, data indicating the changed status is transmitted from the printer 3 to the PC 2. Accordingly, the PC 2 can keep track of the external devices. For instance, if an error occurs in the printer 3, error data indicating the type of the error is transmitted from the printer 3 to the PC 2. The PC 2 selects or produces a program to change a window displayed in the display unit 12 and then transmits the program to the DSC 1. The program is executed in the DSC 1, so that a window, shown in FIG. 7, appears in the display unit 12 of the DSC 1.

FIG. 7 shows an example of a window indicating that the printer 3 is printing. Referring to FIG. 7, in the frame 51, a picture 61 of the printer 3, a frame 62 indicating the same window as that displayed in the display unit of the printer 3, and a character string 63 of “NOW PRINTING” are displayed. Therefore, if the user generates a print instruction from the DSC 1 and the printer 3 starts printing, the window, shown in FIG. 7, appears in the display unit 12. Thus, the user can know the printer 3 is printing.

When the user selects a cancel button 64 in the frame 62 using a button in the operation unit 13, he or she can cancel printing. In this case, data related to a command to cancel printing is transmitted from the DSC 1 to the PC 2. The PC 2 transmits the command to cancel printing to the printer 3 on the basis of the data, so that the printing operation of the printer 3 is cancelled.

Referring to FIG. 7, the color of a picture 65 of an indicator lamp provided for the printer 3 is changed so as to correspond to the status of the printer 3. For example, if the printer 3 is available, the color is white. While printing, the color is green. If an error occurs in the printer 3, the color is red.

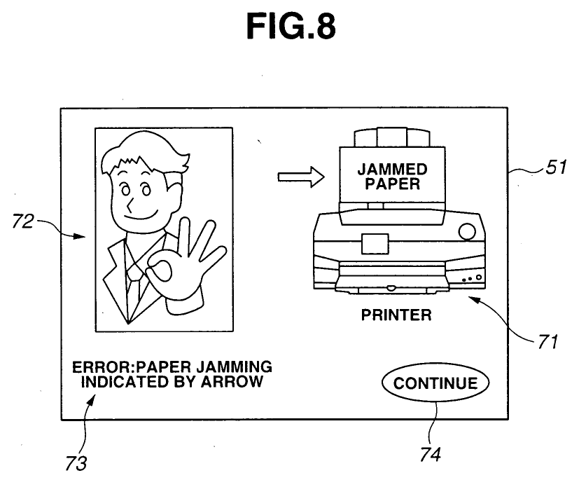

If a paper jam occurs in the printer 3, status data indicating the error is transmitted from the printer 3 to the PC 2. The PC 2 produces a program to display a window indicating the occurrence of a paper jam and transmits the program to the DSC 1. FIG. 8 shows an example of the window indicating the occurrence of a paper jam. Referring to FIG. 8, in the frame 51, a picture 71 of the printer 3 having a paper jam, a picture 72 indicating the fact, a character string 73 indicating the fact, and a button 74 used to continue printing are displayed. Thus, the user can know the printer 3 has a paper jam.

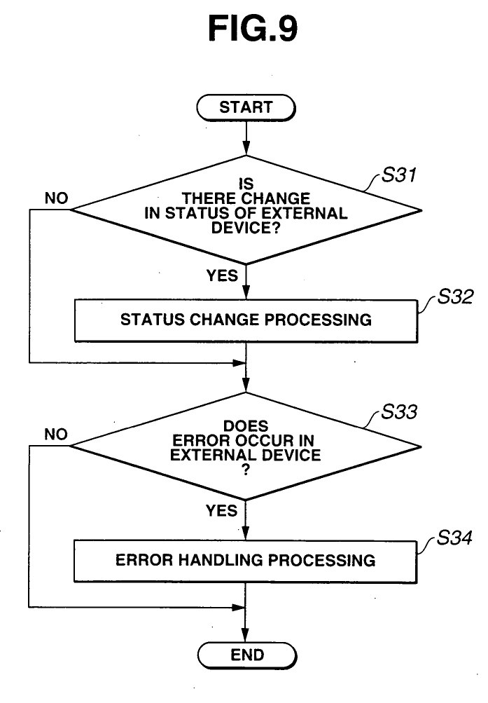

FIG. 9 shows a flowchart of a process including status change processing and error handling processing, the process being performed in the PC 2. Whether the status of at least one external device has changed is determined (S31). Since the PC 2 communicates with the printer 3, the printer 3 transmits data to the PC 2 in order to notify a change in status. Thus, the PC 2 can make the determination.

Then, the PC 2 executes status change processing corresponding to the change in status (S32). For example, if the printer 3 is normally printing, the PC 2 obtains information indicating the normal printing from the printer 3. The PC 2 performs processing to produce a program for forming the window, shown in FIG. 7, corresponding to the status and transmit the program to the DSC 1.

Whether an error occurs in the printer 3 is determined (S33). Since the PC 2 communicates with the printer 3, the printer 3 transmits data to the PC 2 to notify the occurrence of an error. Thus, the PC 2 can make the determination. The PC 2 then performs error handling processing (S34). For example, if a paper jam occurs in the printer 3, the PC 2 receives data indicating the occurrence of the paper jam from the printer 3. The PC 2 performs processing to produce a program for forming the window, shown in FIG. 8, indicating the occurrence of a paper jam in the printer 3 and transmit the program to the DSC 1.

As mentioned above, if a printing error occurs, information indicating that printing is unavailable is displayed in the display unit 12 of the DSC 1. Such information is not displayed in the PC 2 and the printer 3. Therefore, if the user is inexperienced in computer and similar devices, he or she can recognize the occurrence of trouble in an external device.

According to the present embodiment, as shown in FIGS. 5, 7, and 8, the window containing indication items such as pictures and graphics is displayed in the display unit 12. The user selects an indication item in the window, so that he or she can designate a control command for the external device. For example, the indication items corresponding to the control commands include the button 58 in FIG. 5, the button 64 in FIG. 7, and the button 74 in FIG. 8. As mentioned above, the user selects a displayed picture to designate a control command for the printer 3. Alternatively, the user can operate a button on the operation unit 13 of the DSC 1 to designate a control command for the printer 3.

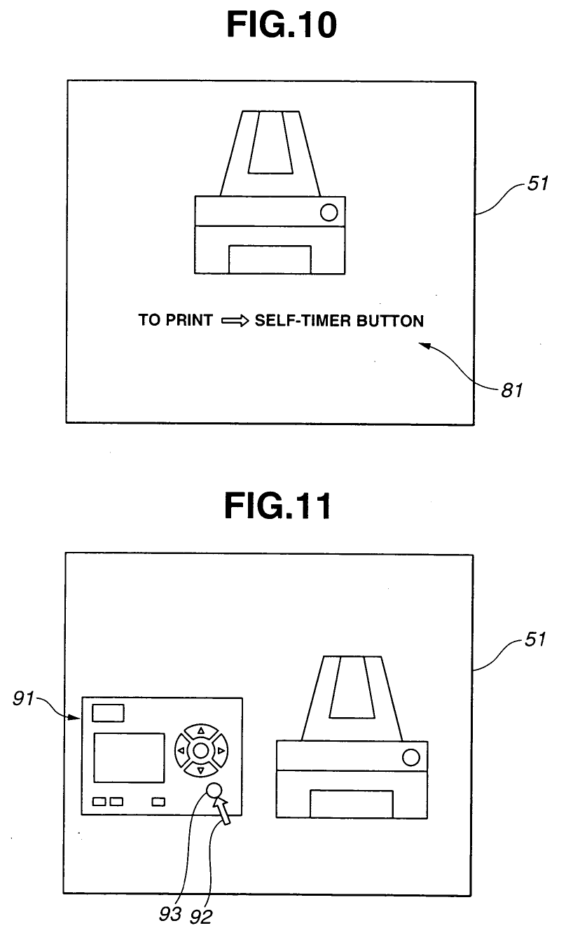

FIG. 10 shows an example of a window displayed in the display unit 12 of the DSC 1. Referring to FIG. 10, a window, produced by the program transmitted from the PC 2 to the DSC 1, indicates that an image based on image data stored in the DSC 1 can be printed. In this case, in order to print an image through the printer 3, the window informs the user that he or she presses a self-timer button by a character string 81. And the self-timer button is one of the operation buttons of the DSC 1. At this time, the DSC 1 is in the external-device control mode. In the DSC 1, therefore, the self-timer button functions as a button for designating a print command for the printer 3. Consequently, when the self-timer button is pressed, the DSC 1 transmits data indicating a print designation command to the PC 2.

FIG. 11 shows an example of another window displayed in the display unit 12 of the DSC 1. In FIG. 11, which is a print designation button in the DSC 1 is shown using a picture. In a picture 91 indicating the external view of the DSC 1, an arrow 92 shows the print designation button. Therefore, if the user presses the button shown by the arrow 92 in the DSC 1, the DSC 1 transmits data related to a print designation command to the PC 2. The print designation button can also be shown by turning on and off a portion 93 corresponding to the button without using an arrow.

Referring to FIGS. 10 and 11, the buttons serving as operating members arranged in the DSC 1 do not serve as buttons for functions of the digital still camera but they serve as buttons for generating an instruction to control the printer 3. Changing an operating instruction for the operating member is realized in such a manner that an operational program, transmitted to the DSC 1 and executed therein, changes the definition of an output for the original function of the operating member arranged in the DSC 1 to switch the output to a signal for controlling the printer 3. Therefore, the CPU 16 and processings in S14 and S15 executed by the CPU 16 define a changing unit for changing an input by an operating member for controlling the DSC 1 to an input for controlling the printer 3.

As mentioned above, according to the present embodiment, if the user is inexperienced in computer and printer operations, he or she can easily operate a printer using a digital still camera using DSC.

In the above explanation, the processes performed between the DSC 1, the printer 3, and the MO 4 have been described. The present system may include more external devices connected to the PC 2. Alternatively, the present system may be composed of the DSC 1, the PC 2, and the printer 3.

In the above-mentioned examples, programs to be transmitted to the DSC have been stored in the storage unit of the PC. To handle data compatible with the latest type printer, table data and programs can be read from a separate storage medium such as a CD-ROM. Further, table data and programs can also be downloaded from a predetermined site on the Internet and be stored in the storage unit of the PC.

In the above-mentioned examples, image data stored in the DSC is output through the external device such as the printer. A mobile phone having a camera function can also be used instead of the DSC. In other words, the mobile phone having the camera function indicates a camera having a mobile phone function.

For the program executed by the PC, the entire or a part thereof is recorded or stored in a portable medium such as a floppy disk or a CD-ROM, or a storage device such as a hard disk. The program is read through a computer, so that the entire or a part of the operation based on the program is performed. Alternatively, the entire or a part of the program can be distributed over a communication network. The user can download the program through the communication network and then install it on their computer. Alternatively, the user installs the program read from a recording medium on their computer. Thus, an image data control system according to the present invention can be easily realized.

As mentioned above, even if external devices, connected to a control device such as a PC, have different formats, the compatibility between the devices can be easily ensured. Thus, the user who is inexperienced in device use can easily operate the devices.

Further, if the user operates one external device connected to a control device such as a PC, he or she can control other external devices without directly operating the control device.

Having described the preferred embodiment of the invention referring to the accompanying drawings, it should be understood that the present invention is not limited to the precise embodiment and various changes and modifications thereof could be made by one skilled in the art without departing from the spirit or scope of the invention as defined in the appended claims.

What is claimed is:

1. A control system comprising:
a first external device having receiving means for receiving a program, the device operating based on the program received through the receiving means;
a second external device capable of operating in association with a command, which is generated from the first external device on the basis of the program received by the first external device; and
a control device connected between the first and second external devices, the device selecting a program to allow the first and second external devices to be operatively associated with each other and transmitting the program to the first external device when it is determined that the first and second external devices are controllably connected, wherein
the second external device is controlled by the command generated from the first external device on the basis of the program.

2. The system according to claim 1, wherein the first external device includes a camera and the second external device includes a printer.

3. The system according to claim 1, wherein the first external device includes a camera capable of generating a print command and the second external device includes a printer which operates based on the print command.

4. The system according to claim 1, wherein
the first external device has a display unit, and
the program allows the display unit to display an indication to select the operation of the second external device and transmits a command corresponding to the selected operation to the control device.

5. The system according to claim 4, wherein the program allows the display unit to display the operational status of the control device operating based on the command.

6. A printing system in which a camera is connected to a printer through a control device, the system including:
a determining unit, included in the control device, for determining whether the camera and the printer are controllably connected;
a selecting unit, included in the control device, for producing or selecting an operating program for allowing the camera and the printer to be operatively associated with each other when it is determined that the camera and the printer are controllably connected;
a program transmitting unit, included in the control device, for transmitting the selected or produced program to the camera;
a program receiving unit, included in the camera, for receiving the operating program from the control device;
an executing unit, included in the camera, for executing the operating program received through the program receiving unit;
an operating member, included in the camera, for entering an input for controlling the camera;
a changing unit, included in the camera, for changing the input for controlling the camera to an input for controlling the printer when the operating member is operated in running the operating program received through the program receiving unit; and
a generating unit, included in the camera, for generating the content of the changed input as an instruction for the printer to the control device.

7. The system according to claim 6, wherein
the camera includes a display unit, and
the program allows the display unit to display an indication to select the operation of the printer and transmits a command corresponding to the selected operation to the control device.

8. The system according to claim 7, wherein the program allows the display unit to display the operational status of the control device operating based on the received command.

9. A control device connected to first and second external devices, the control device comprising:
a determining unit for determining whether image data generated from the first external device is processable by the second external device;
a program producing unit for producing or selecting a program supporting the camera and the printer;
a transmitting unit for transmitting the program to the first external device;
a receiving unit for receiving data related to a first control command, which is formed through the first external device on the basis of the program in order to control the second external device; and
a control command forming unit for forming a second control command to control the second external device on the basis of the received data related to the first control command.

10. The device according to claim 9, wherein the first external device includes a camera and the second external device includes a printer.

11. The device according to claim 10, wherein
the camera serving as the first external device generates a print request command as data related to the first control command, and
the control command forming unit forms a print start command as the second control command to control the printer serving as the second external device in response to the print request command, and generates the print start command.

12. A program for allowing a computer of a control device connected to first and second external devices, the program comprising the steps of:
identifying the first and second external devices connected to the control device;
selecting a control program for controlling the second external device based on an output of the first external device, the program allowing the identified first and second external devices to be operatively associated with each other;
transmitting the selected control program to the first external device; and
executing the transmitted control program to convert an output of the first external device into an instruction to control the second external device.

13. The program according to claim 12, wherein the first external device includes a camera and the second external device includes a printer.

14. A method for controlling a system in which a first external device is connected to a second external device through a control device, the method comprising the steps of:
recognizing the connection between the first and second external devices;
recognizing the respective kinds of the first and second external devices;
selecting a program for changing the content of an instruction generated from an operating member provided for the first external device, the program allowing the first and second external devices to be operatively associated with each other;
transmitting the selected program to the first external device;
executing the transmitted program to change the definition of a signal so that an output, generated from the operating member in the first external device, serves as an instruction output to control the second external device;
generating an output generated from the operating member in the first external device as a first control command for controlling the second external device to the control device; and
analyzing the first control command through the control device to generate a second control command for controlling the second external device to the second external device.

15. The method according to claim 14, wherein the first external device includes a camera and the second external device includes a printer.
